(19) United States
(12) Patent Application Publication
(10) Pub. No.: US 2011/0251987 A1
(43) Pub. Date: Oct. 13, 2011

(54) TIME-SHIFTING A CONTENT STREAMING REQUEST

(76) Inventor: BRIAN K. BUCHHEIT, DAVIE, FL (US)

(21) Appl. No.: 12/759,374

(22) Filed: Apr. 13, 2010

(51) Int. Cl. G06F 15/16; G06N 5/02; G06F 21/00; G06F 17/30; G06F 15/173

(52) U.S. Cl. 706/46; 709/231; 707/769; 709/225; 726/4; 707/E17.014

(57) ABSTRACT

A streaming request from a playback device for media content can be identified. The media content can originate from a unique content source which can be remote from the playback device. The content source can be communicatively linked to the playback device via a public network. Before submitting the request to the unique content source, a non-persisting data store can be queried for the media content. The non-persisting data store can comprise of previously acquired digital media which can be encrypted in a protected manner which remains inaccessible to a user except, when provided responsive to the streaming request. When results of the querying produce a match, the media content from the non-persisting data store can be conveyed to the playback device. When results of the querying do not produce a match, the media content can be requested from the content source and presented to the playback device.

### BACKGROUND

The present invention relates to the field of content delivery and, more particularly, to time-shifting a content streaming request.

Media streaming is a technology which permits a single point-to-point broadcast of a media file. Common media streaming services include RHAPSODY, STREAMCAST, Internet Radio, YOUTUBE, and NETFLIX. Media streaming is designed to permit a controlled playback of requested content, where the control resides at a server. That is, streamed content is not persisted which requires server actions and network connectivity for access to occur. Further, media streaming permits control of media content by content providers which can be critical for media which are associated with licensing schemes.

Media streaming is distinctly different from downloading, which entails conveying a media file to a consumer, who can later view the media file using off-line computing resources only. For instance, downloading a media file can be equivalent to a video rental, where for a price a consumer can purchase a digital media product which is persistent and can be viewed an unrestricted number of times.

FIG. 1 (Prior Art) illustrates a traditional media streaming infrastructure where a client 120 can request content 112 from content server 110 via streaming request 117. Utilizing controls 124, user 130 can request content 112 via streaming interface 122. For instance, when user 130 selects a “play” control in interface 122, request 117 can be communicated to server 110. Once request is received by content 110, content 112 can be conveyed immediately. In the system 100, streaming request 117 and response 112 can be communicated over transport media 118 in real-time or near real-time. For instance, request 117 can be performed during Time A 114 and Time A′ 116. Problems arise with conveying content 112 when server 110 and/or transport media 118 is overloaded, a common occurrence during peak time usage. During peak time usage, sufficient computing resources can be lacking resulting in performance which negatively affects user 130 experience. For example, during prime-time, user 130 can experience choppy playback, low fidelity streaming, and frequent delays.

To compensate for these shortcomings, skip buffer 126 is often employed. Skip buffer 126 can temporarily store a portion of content 112 during streaming playback to compensate for streaming delays. However, during peak time usage transport media 118 can be overloaded which can cause significant delays in communicating streaming content. These delays can be so significant as to render skip buffer 126 ineffective. That is, server 110 can be unable to stream sufficient content due to network delays caused by peak time usage.

At other times, however, server 110 and transport media 118 resources can be under-utilized. During these times, user 130 experience can be favorable and resources 110, 118 can go unused for extended periods of time. It would be beneficial to normalize resource variance without sacrificing control of the streamed content, which is not currently possible.

### BRIEF DESCRIPTION OF THE SEVERAL VIEWS OF THE DRAWINGS

FIG. 1 (Prior Art) illustrates a traditional media streaming infrastructure where a client 120 can request content 112 from content server 110 via streaming request 117.

FIG. 2 is a schematic diagram illustrating a system for time-shifting a content streaming request in accordance with an embodiment of inventive arrangements disclosed herein.

FIG. 3 is a schematic diagram illustrating a system for time-shifting content streaming request utilizing a client-side non-persisting (NP) data store in accordance with the embodiment of inventive arrangements disclosed herein.

FIG. 4 is a schematic diagram illustrating an NP data store associated with a local area network in accordance with the embodiment of inventive arrangements disclosed herein.

FIG. 5 is a schematic diagram illustrating an embodiment for a content offload service for time-shifting a content streaming request in accordance with an embodiment of inventive arrangements disclosed herein.

FIG. 6 is a schematic diagram illustrating a set of streaming interfaces for time-shifting a content streaming request in accordance with an embodiment of inventive arrangements disclosed herein.

FIG. 7A is a flowchart illustrating a method for time-shifting a content streaming request in accordance with an embodiment of inventive arrangements disclosed herein.

FIG. 7B is a flowchart illustrating a method for time-shifting a content streaming request in accordance with the embodiments of inventive arrangements disclosed herein.

FIG. 8 is a schematic diagram illustrating a set of embodiments for time-shifting a content streaming request in accordance with an embodiment of inventive arrangements disclosed herein.

FIG. 9 is a schematic diagram illustrating an system for time-shifting a content streaming request in accordance with an embodiment of inventive arrangements disclosed herein.

### DETAILED DESCRIPTION

The present disclosure provides a solution for time-shifting a content streaming request. In the solution, a content streaming request can be time-shifted to acquire content when computing resources are available. For instance, a media streaming request received during peak network usage can be time-shifted to a period of low network usage. Content can be conveyed in response to the time-shifted request to a non-persisting data store which can be accessed at a user convenient time. The time-shifted request can be automatically conveyed for queued content, which a user has indicated a desire to watch at a future time. In one embodiment, the pre-streaming of content can occur in a user transparent fashion, meaning that a user is unaware that the pre-streaming of queued content has occurred. Content conveyed to the non-persisting data store (pre-streamed content) can be streamed to a playback device when a user selects the content for playback when it is available. If not available, normal streaming of content will be performed responsive to the streaming request. A user can lack direct access to the non-persisting data store, even though that store can be a logical partition (or an entire drive) of a tangible storage medium owned by the user. Space for the non-persisting data store can be user configurable, permitting a user to establish thresholds for memory space available for the “pre-streaming” of media content. That is, non-persisting data store can enabling time-shifting of a streaming content request which is not permissible in traditional streaming environments.

In one embodiment, a streaming request from a playback device for media content can be identified. The media content can originate from a unique content source which can be remote from the playback device. The content source can be communicatively linked to the playback device via a public network.

Before the request to the unique content source is submitted, a non-persisting data store can be queried for the media content. The non-persisting data store can comprise of previously acquired digital media which can be encrypted in a protected manner and can remain inaccessible to a user except, when provided responsive to the streaming request.

When results of the querying produce a match, the media content can be identified within the non-persisting data store and can be conveyed from the non-persisting data store to the playback device. When results of the querying do not produce a match, the media content can be requested via a public network from the content source and a stream associated with the media content can be conveyed to the playback device from the content source in response. The media content can be presented to the playback device.

In another embodiment, a system for selectively streaming media content can comprise of a streaming interface, streaming engine and a non-persisting data store. The streaming interface can be associated with a playback device. The streaming interface can comprise of one or more streaming controls configured to initiate a streaming request for a streaming content to a remote content source associated with a remote content provider. In one embodiment, only a portion (such as a bandwidth consuming portion) of media content can be pre-screened, where a second portion (needed for playback) can be acquired at the time content is requested. This partial delivery of pre-streamed content can reduce a risk of unauthorized use, while successfully time-shifting a portion of the load (bandwidth consumption) associated with media streaming.

The streaming engine can be able to intercept the streaming request for the streaming content initiated by one or more streaming controls. When intercepting the streaming request, the streaming engine can perform a local query to determine the availability of the streaming content in the non-persisting data store prior to a remote query to the remote content source for the streaming content.

A non-persisting data store associated with the playback device can be configured to permit access to the streaming content. The media content can be encrypted in a protected manner and can remain inaccessible to a user except, when provided responsive to the streaming request.

In yet another embodiment, a streaming content request can be conveyed at a first time from a requesting entity to a remote content source. The first time can occur immediately in response to a user-initiated request. The remote content source can be a content provider associated with a content which can be content able to be streamed.

Content from the remote content source can be conveyed at a second time and the content can be associated with a non-persisting data store where the second time can be a significant period of time (hours to days) after the first time. The content associated from the non-persisting data store can be streamed to a requesting entity at a third time, wherein the third time is significantly different from the second time. The content can be presented within a streaming interface at the third time.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

FIG. 2 is a schematic diagram illustrating a system 200 for time-shifting a content streaming request in accordance with an embodiment of inventive arrangements disclosed herein. In system 200, content 212 can be time-shifted in response to a streaming content request 217. For example, streaming request 217 can occur at Time A 214 which can trigger content 212 to be time-shifted and conveyed to non-persisting (NP) data store 240 at Time B 216. In one embodiment, content 212 conveyed to NP data store 240 can be accessed independently of server 210 and media 218. For instance, at Time C 219, a user 250 can access content 212 for playback via streaming interface 232 when server 210 is unavailable. In another embodiment, playback of content 212 can require server 110 availability, as an unlocking code, an authorizing code, and/or additional content that integrates with content 212 may be needed for playback.

Streaming controls 234 can be one or more hardware/software entities permitting manipulation of a content stream associated with content 212. Hardware entities can include physical buttons, such as on a DVD player, media player, or remote control. Software entities can include user selectable interface controls rendered within a user interface, which a user can select. Software entities can be stored on a tangible medium and can include controls presented on different types of user interfaces, including graphical user interfaces (GUI), voice user interfaces (VUI), text user interface (TUI), and the like. Streaming controls 234 can be a user responsive element able to initiate a streaming request 217 to obtain content 212 from a content server 210. Controls 234 can include be one or more traditional streaming playback controls including, but not limited to, play, pause, stop, fastforward, rewind, and the like. In one embodiment, controls 234 can permit user 250 to timeshift content 212 utilizing streaming request 217.

In one embodiment, request 217 can be generated when user 250 interacts with streaming controls 234 to initiate playback of a content 212. That is, request 217 can be manually initiated by a user 250 in one arrangement. In another arrangement, server 210 can be aware of content 212 that a user 250 has desired to watch (e.g., an streaming queue associated with the user) and/or can predict from past user 250 behavior (i.e., using a predictive algorithm based on a user's profile 250 indicating user preferences, interest, historical viewing habits, and the like) content 212 that user 250 is likely to want to watch in a relatively near future. For example, a predictive algorithm of server 210 (or intermediary server performing the pre-screening functions) can pre-stream new releases of popular action/adventure movies to non-persisting data store 240, as historical patterns show user 250 watches these types of new releases 85% of the time within two days of their availability. Thus, when server 210 and/or media 218 is experiencing peak time usage, the providing of content 212 in a time-shifted fashion to non-persisting data store 240 reduces the peak time usage load. In instances, when server 210 and/or media server 218 is not experiencing peak time usages, content 212 can be streamed to client 230 in a traditional manner, in one embodiment.

Content 212 can be time-shifted and associated with NP data store 240 at a time different from request 217. That is, when server 210 and/or media 218 resources are sufficiently available request 217 can be processed and content 212 can be communicated to NP data store 240. When content 212 is present in NP data store 240, client 230 can communicate with data store to access content 212. Content 212 can be conveyed to client 230 and presented in streaming interface 232 in response to a playback request. It should be appreciated that system 200 can operate in a user transparent fashion such that user 250 need not be aware of the location of content 212. That is, regardless of content server 210 and media 218 resource load client 230 can access content 212 in a performance consistent manner during playback.

It should be noted, Time A 214, Time B 216, and Time C 219, are not immediately subsequent times and significant durations of time can exist between each time 214, 216, 219. For instance, Time A 214, Time B 216, and Time C 219 can correspond to various times during a day (e.g., morning, noon, dusk) Since NP data store 240 does not persist content 212, content associated with data store 240 can be subject to temporal limitations, licensing restrictions, and the like. For instance, content 212 can expire after a content provider determined duration which can render the content unavailable for playback.

Specifics for pre-streaming or time shifting of streaming in system 200 can depend upon arrangements and positioning within a network of the non-persisting data store 240 relative to the position of the server 210 and the playback device 230. It can also depend on hardware, network architecture specifics pertaining to the devices. Pre-streaming can occur to enhance image quality of content 212 available to the user 250, and/or to correct for analyzed network bottlenecks existing between the end-to-end connections (from server 212 to client 230).

For example, in one embodiment, the non-persisting data store 240 can be embedded within client 230, which is connected to a home based gateway via a “weak” home area network. This home area network may not provide a consistent bandwidth sufficient for streaming high fidelity content 212 in a traditional manner. Since data store 240 is not subject to this bandwidth limitation, smooth playback of streamed content 212 is possible through use of the pre-streaming and data store 240. In this example, a portion of the content 212 that is pre-streamed can be calculated based on available bandwidth to client 230 (over the home media network)

In another embodiment, the non-persisting data store 240 can be positioned upstream of the content server 410 relative to a backbone of the public network 420. This arrangement can be highly advantageous when upstream bandwidth from the content server 410 is limited. For example, the content server 410 can include a home media server, such as a windows home server (WHS) device. This device (server 410) can be connected at a terminal end of a last-mile of a communication connection. This last mile can bias communications to prefer downloading over uploading (e.g., 6 M/s downstream; 700 Kb/sec upstream) which is a common practice for internet service providers. The time-shifting nature enabled through the non-persisting data store 240 can ensure content 212 or portions thereof is located in a bandwidth favorable location, relative to that of the content server 210 for purposes of streaming load. Thus, even through an end-to-end connection from the content server 210 to client 230 may only support streaming at a relatively low fidelity; this fidelity can be increased by placing non-persisting data store 240 upstream from content server 210. This arrangement can be useful to enhance a content server's 210 ability to serve/stream media to others. Thus, it can be implemented as part of an optimizing Web service enacted for entities streaming content to others. For example, a WHS device can subscribe to a Web service for efficient streaming, which operates in accordance with this disclosure.

In one embodiment, multiple different non-persisting data store 240 can be utilized. For example, one data store 240 can supplement bandwidth from the server side 210 to a communication backbone (e.g., from a last-mile or middle mile connection) and a second data store 240 can be positioned client side 230 (e.g., positioned at the edge of a middle-mile of a connection before a last-mile to the residence in which the client 230 is housed). Such an arrangement can be specifically designed by a service provider (e.g., a carrier) to optimize an ability to bi-directionally stream without overloading network 420 resources at peak load times. Thus, a carrier (bandwidth provider) can benefit from the time-shifting of streamed content, implemented in accordance to the present disclosure. In another disclosure, multiple non-persisting data stores can exist.

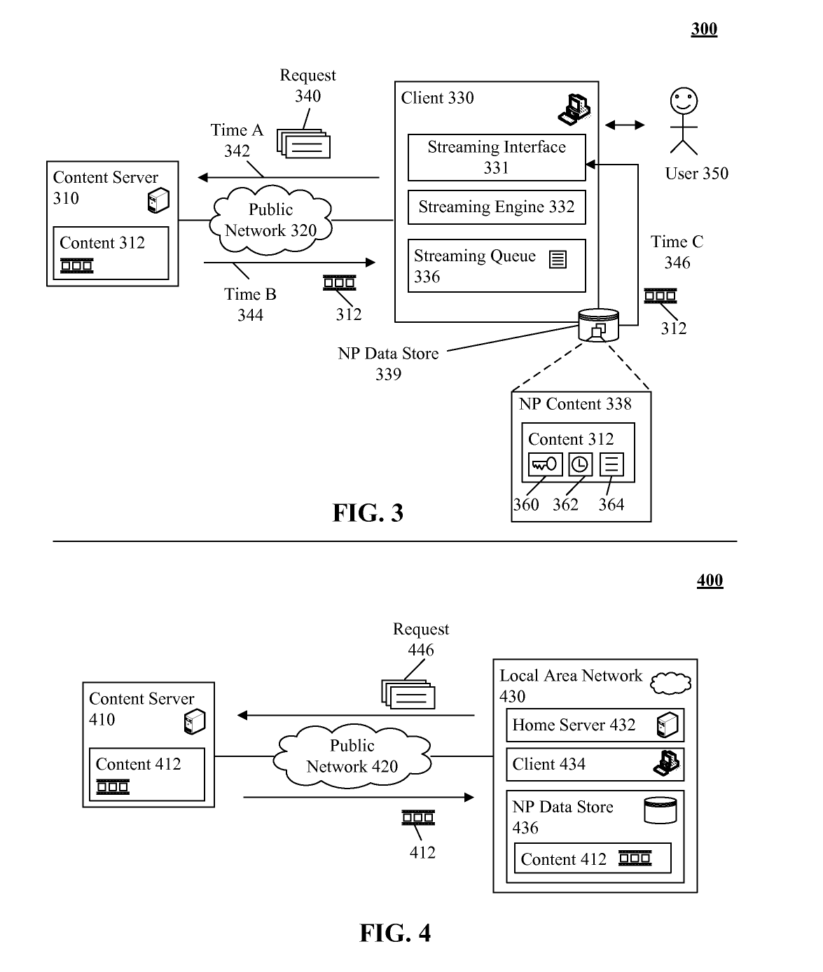

FIG. 3 is a schematic diagram illustrating a system 300 for time-shifting content streaming request utilizing a client-side non-persisting (NP) data store in accordance with the embodiment of inventive arrangements disclosed herein. In system 300, a content streaming request 340 occurring at Time 342 for content 312 can be time-shifted. The content 312 can be conveyed to a client-side NP data store 339 via public network 320 at Time B 344. During playback of content 312, streaming engine 332 can access content 312 from NP data store 339 at Time C 346.

As used herein, NP content 338 can include content 312 provided by server 310. NP content 338 can include content provided by one or more content servers and/or providers. In one embodiment, NP content 338 can be a digital media library comprising of digitally rights managed content. In one configuration of the embodiment, NP content 338 can include user purchased content.

NP content 338 can be digitally rights managed content protected by one or more content protection schemes. For example, content 338 can be a PLAYREADY encoded file. NP content 338 can include content 312 which can be associated with one or more control mechanisms including but not limited to, an authorization code 360, a timeout value 362, and content settings 364. Control mechanisms 360, 362, 364 can impose access restrictions on content 312 associated with licensing schemes, subscription service, and the like.

Authorization code 360 can be a one or more authorization mechanisms for granting access to content 338 playback. In one embodiment, authorization code 360 can be associated with a public key infrastructure (PKI). In the embodiment, authorization code 360 can be a public key corresponding to a private key encoded content associated with the content streaming request. In one embodiment, authorization code 360 can be a hash value generated from the content associated with the content streaming request.

Timeout value 362 can be a content provider established setting determining the lifetime duration content 338. For instance, value 362 can be an expiration setting permitting content 338 to exist within NP data store 339 for twenty four hours before it is automatically deleted. In one instance, timeout value 362 can be a playback associated setting. In the instance, timeout value 362 can be used to specify playback licensing restrictions. For instance, timeout value 362 can permit content to expire after playback is performed.

Content settings 364 can include one or more content specific settings. Settings 364 can be content provider established and/or user 350 established. Settings 364 can include, but are not limited to, playback quality settings, playback tracking settings, user 350 established playback preferences, and the like.

Streaming engine 332 can be a hardware/software component able to time-shift a content streaming request. Engine 332 can utilize streaming queue 336 to perform time-shifting of a content streaming request. Engine 332 can process streaming queue 336 for a pending content streaming request and communicate a content streaming request to content server 310. Once the content streaming request has been communicated, the engine 332 can update streaming queue 336 to reflect the current state of the content streaming request. Engine 332 can receive content 312 associated with the content streaming request 340. In one instance, engine 332 can record content 312 to NP data store 339. Engine 336 can continuously update streaming queue 336 based on received content 312. It should be appreciated that engine 332 can continually process content streaming requests associated with streaming queue 336 and time-shift the content streaming request for the lifetime of the streaming queue 336. For instance, as users add content of interest to streaming queue 336, engine 332 can automatically initiate and manage time-shifting content streaming requests.

When user 350 initiates playback of content 312, content 312 can be streamed from NP data store 339 to engine 332. Engine 332 can convey content 312 stream to streaming interface 331 where the content 312 can be presented to user 350. It should be noted that playback of content 312 from NP data store 339 can be indistinguishable from content streamed from content server 310.

In one embodiment, engine 332 can include one or more digital rights management functionality enabling traditional digital rights management (DRM) to be supported.

Streaming queue 336 can be a user manipulated artifact comprising of one or more user initiated streaming requests which can be represented as a content item within queue 336. For instance, queue 336 can be a list of movies a user 350 is interested in viewing. In one instance, queue 336 can permit content 312 to be requested by placing an entry for the content in the queue 336. For instance, a user can request a movie by adding the title of the movie to the queue 336. In one instance streaming queue 336 can be one of multiple streaming queues. For instance, a user 350 can establish multiple streaming queues 336 for each genre of film the user 350 is interested in.

In one embodiment, queue 336 can be stored within client 330. In another embodiment, queue 336 can be stored by a content provider associated with server 312. Queue 336 functionality can include traditional content queue functionality including user customization, prioritization, and the like. User management functionality can include, but is not limited to, adding a content item, deleting a content item, substituting a content item, and the like.

Although NP content 338 is stored within a client associated entity (e.g., NP data store 339), content provider can remain in control of content. That is, NP content 338 can be managed solely by content provider and can be immutable to user 350. In one instance, access to NP content 338 can be restricted to streaming engine 332 and/or authorized playback components. For example, NP content 338 can be accessible only to user 350 via streaming interface 331.

As previously noted NP content 338 can consistent of less-than an entire content 312 of a media file to be played. For example, the first X bits of a frame having Y bits can be included as NP content 338, where X-Y bits are still needed from a server 310 during a streaming operation, where X-Y is a positive number of bits. In such an embodiment, the NP content 338 may be entirely unsuitable for playback, yet use of the NP data store 339 still manages to shift a portion of the end-to-end load required for streaming content 312 from the server 310 to the client 330. Alternatively, gapped time segments (e.g., a one second gap occurring every two seconds of content, which results in a time-shifting of approximately ⅔ of the content 312) of content 312 can be conveyed to NP data store 339, which are theoretically playable by client 330, yet would result in a choppy/unpleasant viewing experience. Encryption can also be used to ensure the content 312 is unplayable, except when keys or activation codes/certificates (which can be time-dependent and/or variable) are provided by server 310. Thus, in various embodiments, the content 312 as stored in NP data store 339 is distinguishable from pay-per-view and other stored/cached content in many ways, which are unrelated to usage.

FIG. 4 is a schematic diagram illustrating an NP data store 436 associated with a local area network 430 in accordance with the embodiment of inventive arrangements disclosed herein. In system 400, a content 412 can be time-shifted to an NP data store 436 associated with a local area network 430. Content server 410 can convey content 412 over public network 420 in response to request 446. Content 412 can be associated with NP data store 436 which can be retrieved upon initiation of playback from client 434. For instance, streaming request 446 can be received at Time A 442 which can trigger content 412 to be communicated to local area network 430 at Time 444.

Local area network 430 can be a user established network permitting one or more computing devices to stream content within the network 430. Local area network 430 can include, but is not limited to, home server 432, client 434, and NP data store 436. For example, network 430 can be a home network with a media server able to stream media to a television. Network 430 can permit communication between components 432-436.

Home server 432 can be one or more computing devices able to store, manage, and/or share content. Server 432 can be a home entertainment server able to store and stream content to client 434. In one embodiment, server 432 can be a MICROSOFT WINDOWS HOME SERVER (hosting a WHS operating system, or the equivalent software providing streaming capabilities). Server 432 can communicate with data store 436 to stream content 412. Content 412 can be streamed to client 434 locally from server 423. That is, server 432 can intercept a remote streaming request for content 412 from client 434 and stream content 412 to the client 434.

In one instance, NP data store 436 can be a user owned computing element. For example, NP data store 436 can be a hard drive owned and operated by a user. In another instance, NP data store 436 can be a content provider controlled device. For instance, data store 436 can be a component of a set-top box provided by a content provider able to stream content from NP data store 436 to client 434.

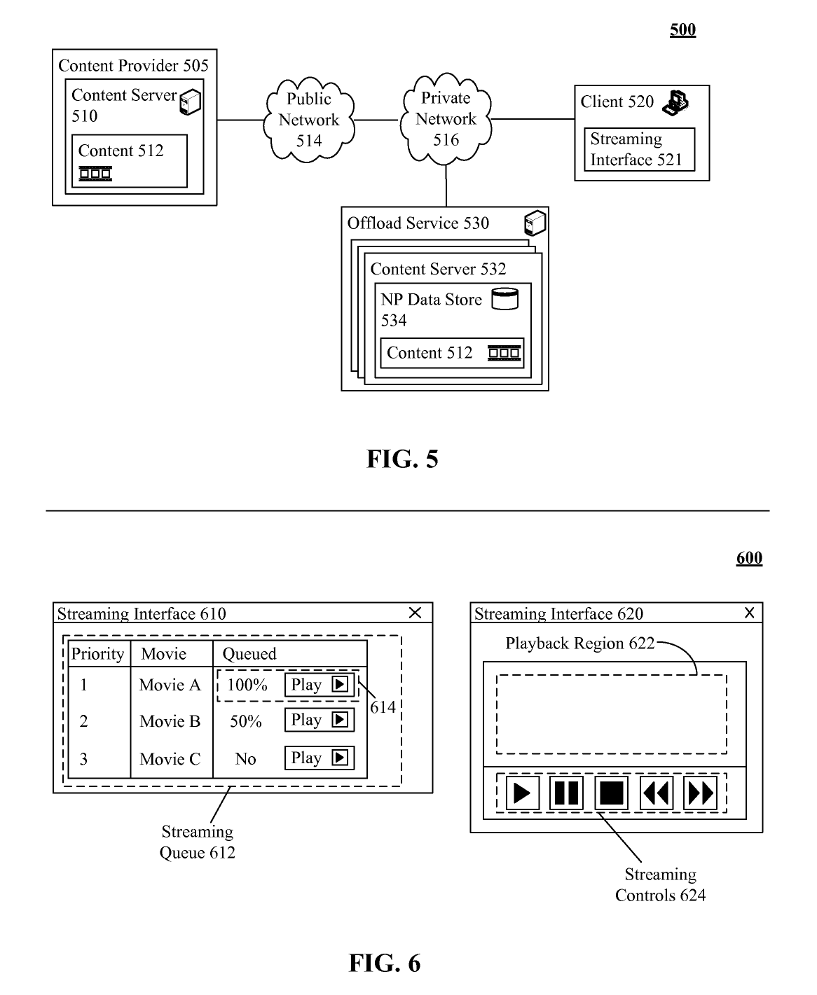

FIG. 5 is a schematic diagram illustrating an embodiment 500 for a content offload service 530 for time-shifting a content streaming request in accordance with an embodiment of inventive arrangements disclosed herein. In embodiment 500, a content server 510 can be communicatively linked with an offload service 530 via public network 514 and/or private network 516. That is, offload service 530 can be a component of a content distribution network. Server 510 can convey content 512 associated with a time-shifted streaming request to an offload service 530 permitting access to content 512 via service 530. When a streaming request is initiated from streaming interface 521, content 512 can be conveyed from service 530 over network 516 to client 520. That is, service 530 can act as an upstream content provider for time-shifted content.

In one embodiment, offload service 530 can be one or more services owned and/or operated by content provider 505. In the embodiment, offload service 530 can be a subscription based service associated with a content provider. For example, service 530 can be part of a cable television service offering enabling users to enjoy uninterrupted streaming content playback.

In another embodiment, offload service 530 can be a third party entity operating cooperatively with content provider 505. In the embodiment, local content providers can host content 512 allowing local technology infrastructures to be utilized to enable service 530 to be available to any client 520 regardless of location. For example, service 530 can serve distinct geographic regions when content provider 505 experiences peak usage.

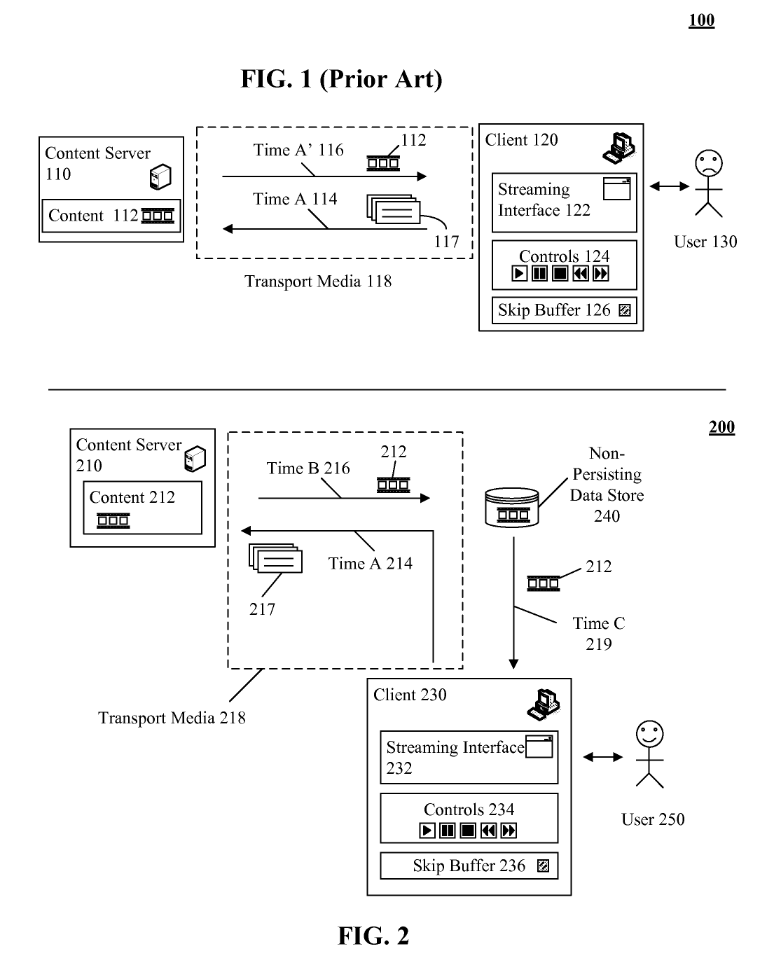

FIGS. 1-5 presented herein are for illustrative purposes only and should not be construed to limit the invention in any regard. It should be noted that for clarity, one or more traditional components of client have been optionally omitted from FIGS. 1-5.

As used herein, streaming can refer to communicating content to a requesting entity from a remote content source in response to a streaming content request and presenting the communicated content in real-time. A streaming content request is a request for streaming content associated with a remote content source that is communicated immediately to the remote content source in response to a requesting entity petition. In one instance, streaming content can be media content encoded for streaming. For example, media content can be a Motion Picture Experts Group 4 (MPEG-4) encoded file. In another instance, streaming content can be media content not encoded for streaming.

As used herein, time-shifting can include conveying a content stream at a different time (e.g., Time B 216) than the time (e.g., Time A 214) the content streaming request is initiated. The conveyed content stream can then be accessed at a time different (e.g., Time C) from the conveying time via streaming controls 234. In one instance, Time A 214 and Time C 219 can be a peak-time and Time B 216 can be non-peak time. Peak time can refer to a duration of time where content server and/or transport media resources are not sufficiently available to convey content in real-time. Non-peak time can refer to a duration of time where content server and/or transport media resources are sufficiently available to convey content in real-time.

Time-shifting can be facilitated by a non-persisting data store (e.g., non-persisting data store 240) able to receive content stream (or a portion thereof) at a first time and communicate content stream at a second time in response to a streaming request. Content stream can refer to a real-time and/or near real-time communication of content in response to a streaming request. In one embodiment, content stream can include one or more real-time communication protocols including, but not limited to, real-time streaming protocol (RTSP), real-time transport protocol (RTP), and the like.

As used herein, streaming content can include one or more digitally encoded artifacts stored in a computer readable medium. Content can include, but is not limited to, audio content, video content, multimedia content, text content, and the like. Content can be encoded in one or more streaming codecs including, but not limited to, H.263, MICROSOFT WINDOWS MEDIA VIDEO, and the like. For example, content can be a Moving Picture Experts Group 1 Audio Layer 3 (MP3) file.

Content can be protected by one or more encryption/security mechanisms. In one instance, content can be associated with a digital rights management scheme. Digital rights management (DRM) can be one or more access technologies able to impose limitations on the usage of content. DRM can include, but is not limited to, FairPlay, MICROSOFT WINDOWS MEDIA DRM, and the like.

In one instance, content can be encrypted utilizing one or more industry standard and/or proprietary cryptographic mechanisms. For example, content can be encrypted with It should be noted that content associated with a non-persisting (NP) data store can remain under the control and/or management of content server and/or a content provider.

As used herein, a content server can represent one or more computing devices associated with a remote content provider. Remote content provider can include, but is not limited to, an entity providing a content service permitting provider controlled content to be streamed to a requesting entity. In one embodiment, the content service can be a subscription based (e.g., NETFLIX) service. A server can receive a streaming request and communicate content based on server and/or media operating conditions. For instance, server 210 can include a load monitor able to determine when resources are unavailable (e.g., peak time) and time-shift content in response to resource availability. Similarly, transport media can be monitored to determine when a request can be appropriately processed and content can be conveyed.

Client can include one or more computing devices able to initiate a streaming request for content and receive a content stream. Client can include, but is not limited to, streaming interface, skip buffer, streaming engine, streaming controls, and the like. In one embodiment, client can be a set-top box issued by a content provider to a subscriber. For instance, client can be a digital video recorder (DVR) able to receive content from a NP data store and present the content within a streaming interface. Client can include, but is not limited to, a personal computer, a laptop, a portable media player, mobile phone, personal digital assistant (PDA), and the like.

Skip buffer can be one or more data buffers associated with streaming interface able to temporarily store data from a content stream immediately preceding and/or following playback of content. For example, buffer can be a memory buffer able to minimize content stream interruption during playback. In one instance, skip buffer can be playback buffer associated with a random access memory (RAM) component of computing device. That is, skip buffer can be utilized during playback to ensure a uniform playback experience. As such, skip buffer can conform to traditional playback buffer functionality when used to playback content.

Streaming interface can be a user interface able to present a time-shifted content stream to a user. Interface can include, but is not limited to, graphical user interface (GUI), voice user interface (VUI), multi-modal interface, and the like. Interface can be one or more components of a streaming content application. For example, interface can be a content selection interface, permitting user to select content of interest to be viewed. Streaming interface can be associated with one or more streaming controls (e.g., playback controls). In one embodiment, interface can be a software application permitting a content stream from a NP data store to be presented to a user. For instance, interface can be a WINDOWS MEDIA PLAYER application able initiate a playback request at Time A and present content at Time C.

A public network can be one or more telecommunications networks communicatively linked to provide communication functionality to a public entity. Public network can include, but is not limited to, a public data network. For instance, public network can be a digital communications network such as a packet switched network. In one embodiment, the public network can include the Internet.

A private network can be one or more telecommunications networks communicatively linked to provide communication functionality to a private entity. Private network can include, but is not limited to, a virtual private network, intranet, and the like. For instance, private network can be a content delivery network associated with a content provider.

FIG. 6 is a schematic diagram illustrating a set of streaming interfaces 610-612 for time-shifting a content streaming request in accordance with an embodiment of inventive arrangements disclosed herein. Interfaces 600 can be presented in the context of system 200-500. In interface 610, a streaming queue 612 can be utilized to initiate and manage a time-shifted content streaming request. In interface 620, playback controls 616 can be employed to initiate and control a playback of a time-shifted content.

In interface 610, a streaming queue 612 can be presented to a user enabling management of content streaming requests associated with streaming content. Streaming queue 612 can include content item entries for each time-shifted content request a user initiates. For instance, each movie (e.g., Movie A) a user selects to view can be automatically added to streaming queue 612. In one instance, queue 612 can permit organization of time-shifted content requests. In the instance, queue 612 can present an ordered list of time-shifted content request based on completion progress. For instance, queue 612 can present content in an NP data store ready to be viewed at the top of the queue. In another instance, queue 612 can present time-shifted content requests based on chronological order. For example, the most recent time-shifted content request can appear at the top of the queue.

In one embodiment, queue 612 can be automatically updated in response to historic user content requests. For instance, content can be added to a streaming queue based on historic user preferences. In another embodiment, queue 612 can enable management of multiple content streaming requests.

Queue 612 can include functionality 614 to manage time-shifted content streaming request including, but is not limited to, progress indicator, playback initiation control, and the like. In one instance, queue 612 can present the status of a time-shifted streaming request. For instance, queue 612 can present the percentage of content streamed to an NP data store. In another instance, queue 612 can present queue management features such as prioritizing, canceling a time-shifted streaming request, and the like. In one instance, interaction with functionality 614 can present interface 612.

In interface 620, a time-shifted content can be presented in response to a user initiated playback action. Interface 620 can include, but is not limited to, playback region 622 and streaming controls 624. In one embodiment, playback region 622 can present time-shifted content in a traditional manner. That is, no distinction between streamed content and time-shifted content can be determined. In another embodiment, region 622 can indicate when time-shifted content is being presented. For instance, an icon indicating time-shifted content is being presented can be displayed in region 622. Streaming controls 624 can be used to manipulate playback of content associated with a time-shifted content request. In one embodiment, controls 624 can be used to playback time-shifted content associated with an NP data store when the content is available in the NP data store. In the embodiment, controls 624 can permit seamless transition between content streamed from the NP data store and content streamed from a content provider. That is, when streamed content from NP data store is not available, playback region 622 can present content streamed from a content provider.

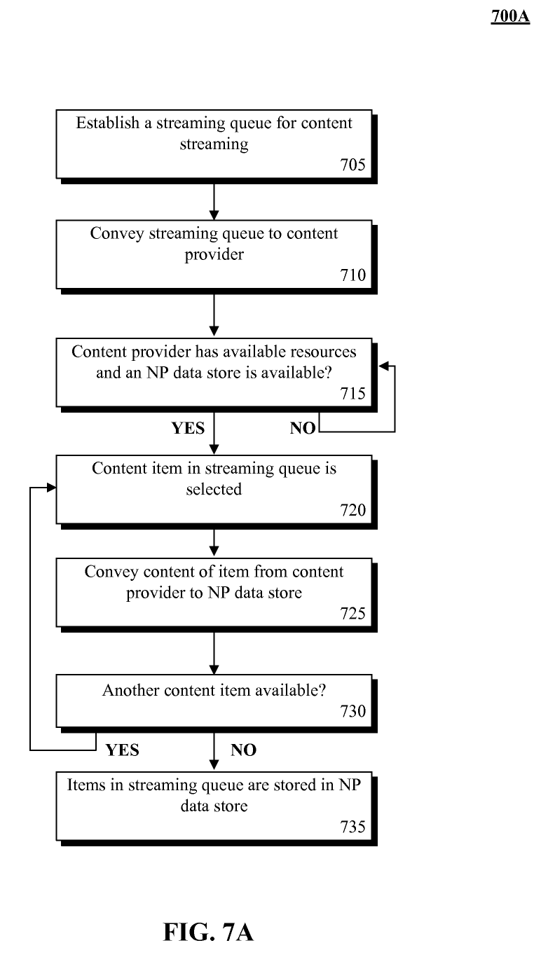

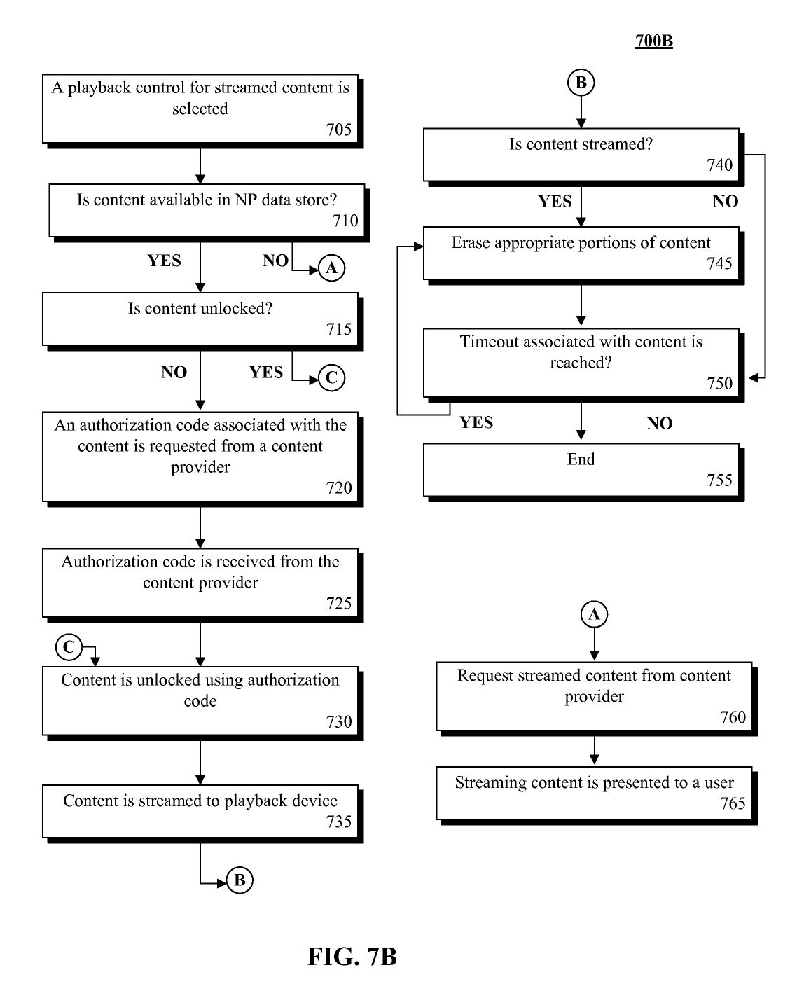

FIG. 7A is a flowchart illustrating a method 700A for time-shifting a content streaming request in accordance with an embodiment of inventive arrangements disclosed herein. Method 700A can be performed in the context of system 200-500. In method 700A, a streaming queue can be utilized to time shift a content streaming request. The streaming queue can be processed by a content provider to time shift user request content when resources are available. For instance, during non-peak time, each content item in the streaming queue can be processed to convey queued streaming content to requesting clients. Alternatively, a predictive (or forecasting) algorithm can be employed to create a “streaming queue” for a recipient that includes a list of content (e.g., media) items that the recipient is likely to be interested in. This predictive or automatic queue can be established based on user feedback (e.g., user customizable settings regarding the automatic queue, user preferences, etc.), in one contemplated implementation. In another, the predictive queue can be established without the user's explicit knowledge or feedback. That is, an end-user may not know of the existence of a predictive queue, its inner-workings, or even that a NP data store is being used to time-shift queuing load. In such a case, the end-user may simply notice improved performance, such as an increased responsiveness to a user initiated streaming request (caused by at least a portion of the requested content having been time shifted to the NP data store).

In step 705, a streaming queue for content streaming can be established. Streaming queue can be user established, can be content provider established, or both. As noted, the streaming queue can be a predictive queue or an explicitly established one. For example, in one instance the streaming queue can be automatically generated based on historic user requests. In one embodiment, streaming queue can be manually generated by a user. In step 710, streaming queue can be conveyed to content provider (or an intermediary agency time-shifting streaming content via a NP data store, such as offload service 530). In one instance, streaming queue can be conveyed to content provider when a user modification is performed on streaming queue. In one configuration of the instance, a streaming queue delta can be generated and conveyed to content provider. That is, only changes enacted by a user (e.g., adding a content item) can be communicated. In another configuration of the instance, the streaming queue can be conveyed in its entirety. In one embodiment, streaming queue can be conveyed to content provider periodically. For example, during periods of client inactivity, queue can be communicated to content provider to be processed and streaming content can be conveyed to the inactive client.

In step 715, if content provider has available resources and NP data store is available, the method can continue to step 720, else return to step 715. In step 720, a content item in the streaming queue can be selected. Content item can be linked to streaming content utilizing one or more traditional content management schemes. In one instance, content item can be associated with a unique Uniform Resource Identifier which can identify a streaming content. In step 725, content of item from content provider can be conveyed to NP data store. In step 730, if another content item is available, the method can return to step 720, else continue to step 735. In step 735, items in streaming queue can be stored in NP data store.

FIG. 7B is a flowchart illustrating a method 700B for time-shifting a content streaming request in accordance with the embodiments of inventive arrangements disclosed herein. Method 700B can be performed within the context of system 200-500. In method 700B, a playback control for streamed content can be selected. For instance, a user can select a content to playback and press the “play” button control on a television remote. In step 710, if content is available in NP data store, the method can continue to step 715, else proceed to step 760. In step 715, if the content is unlocked, the method can proceed to step 730, else continue to step 720. In step 720, an authorization code associated with content can be requested from a content provider. In one embodiment, authorization code can be requested from a content licenser to enable content licensing schemes to be supported. In step 725, authorization code can be received from the content provider. In step 730, content can be unlocked using the received authorization code. In one instance, content can remain unlocked for a content provider specified duration once the authorization code is utilized. For instance, content can remain unlocked during a playback session, reducing excessive communication with a content provider. In step 735, content can be streamed to a playback device. In step 740, if the content is streamed, the method can continue to step 745, else proceed to step 750. In step 745, appropriate portions of the streamed content can be erased. In one instance, content can remain within the NP data store and can be locked with a different content provider issued authorization code. Since, users tend to view the same content repeatedly; this instance can permit content reuse and resource use mitigation. That is, content need not be retransmitted once playback is finished. In step 750, if a timeout (e.g., timeout 362) associated with the content is reached, the method can return to step 745, else continue to step 755. In step 755, the method can end. In step 760, streamed content can be requested from the content provider. In step 765, the streaming content can be presented to a user.

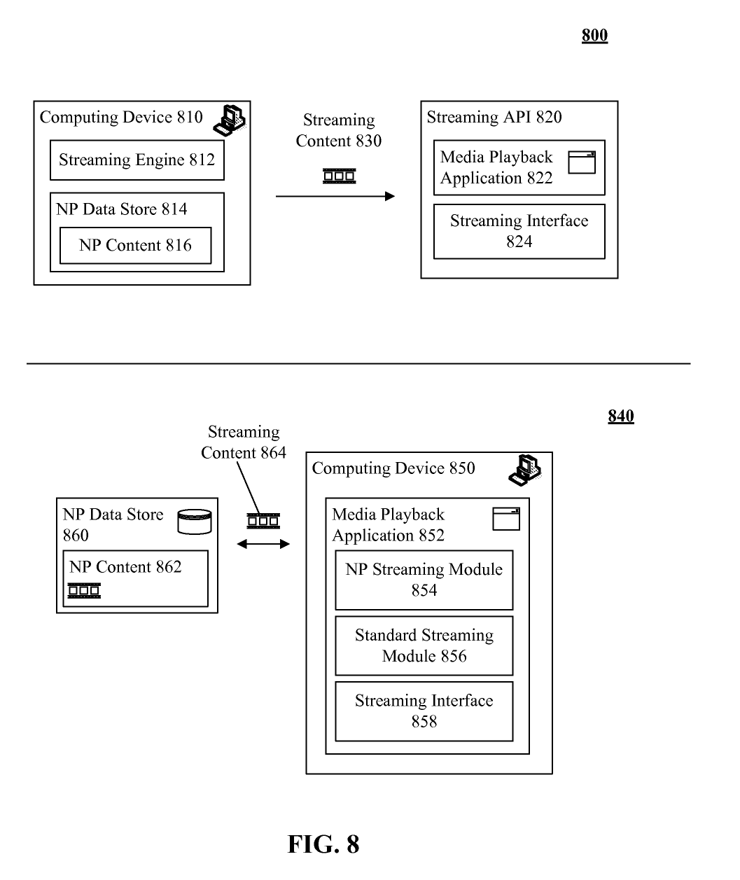

FIG. 8 is a schematic diagram illustrating a set of embodiments 800, 840 for time-shifting a content streaming request in accordance with an embodiment of inventive arrangements disclosed herein. In embodiment 800, a computing device 810 can convey NP content 816 to a streaming application programming interface (API) 820 as streaming content 830. In embodiment 840, media playback application 852 can selectively utilize streaming modules 854, 856 to perform a streaming request and/or execute a time-shifted streaming content request.

In the embodiment 800, streaming engine 812 can access NP data store 814 and communicate NP content 816 to API 820. In one configuration of the embodiment, streaming engine 812 can encode NP content 814 for transmission to streaming API 820. That is, streaming content 830 can be differently encoded from that of NP content 816. For instance, content 830 can be protected by high bandwidth digital content protection (HDCP) during transmission. In one instance, engine 812 can encrypt content 816 in real-time prior to transmission to API 820.

Streaming API 820 can be one or more software components able to receive and present a streaming content 820. API 820 can include, but is not limited to, media playback application 822 and streaming interface 824. In one embodiment, API 820 can be a plug-in module enabling traditional streaming interfaces to perform time-shifting functionality. In another embodiment, API 820 can be a replacement API for a traditional streaming API. For instance, API 820 can exist simultaneously with traditional streaming APIs and when time-shifting a content streaming request is initiated, API 820 can be utilized instead of traditional APIs. In another embodiment, API 820 can be a wrapper API, able to enhance functionality of application 822 and interface 824.

Media playback application 822 can be a hardware/software component for receiving a content stream associated with a time-shifted content request. Application 822 can include one or more decoding functionalities including, but not limited to, digital rights management decoding capabilities, encryption/decryption functionality, and the like. For example, playback application 822 can be a content provider issued application, permitting access to NP content 816.

In embodiment 840, media playback application 852 can be a streaming media application able to interact with an NP data store 860. Application 852 can comprise of NP streaming module 854, standard streaming module 856, and streaming interface 858. NP streaming module 854 can exist simultaneously with standard streaming module 856. When a traditional streaming request is initiated, standard streaming module 856 can be utilized. When a time-shifted content streaming request is initiated, NP streaming module 854 can be selectively utilized. In one embodiment, module 854, 856 can be selectively enabled/disabled in response to content streaming requests.

In one configuration, media playback application 852 can be a content provider produced application. In one instance of the configuration, application 852 can perform selectively based on a level of service purchased from content provider. For example, as part of a free offering, streaming module 856 can be solely enabled and paid offerings can include NP streaming module 854 being enabled.

NP streaming module 854 can be a streaming module permitting communication with an NP data store 860. In one instance, module 862 can transmit a “heartbeat” to NP data store 860 during content streaming to enable automatic content deletion. In one configuration of the instance, module 862 can communicate the current position in a content stream which is presented within streaming interface. That is, module 854 can permit data store 860 to determine which portions of the content stream can expire and consequently be removed.

Standard streaming module 856 can be a traditional hardware/software streaming element within a media playback application 852. In one instance, standard streaming module 856 can be a content provider plug-in for enabling traditional streaming capabilities for media playback application.

Streaming interface 824, 858 can be a hardware/software component permitting interaction with media playback application 822, 852. In one instance, interface 824, 858 can permit configuration of media playback application 822, 852. In the embodiment, interface 824, 858 can allow a user to specify streaming content quality for each module. For instance, NP streaming module 854 can be configured for high fidelity playback where standard streaming module 856 can be configured for a lower fidelity playback to compensate for content provider resource availability. That is, a user can experience high fidelity playback utilizing NP streaming module 854 without incurring overhead (e.g., network bandwidth usage) typically associated with streaming high fidelity content.

In one embodiment, streaming engine 812 (or other engine, such as one of content server 532 or 510) and/or playback application 822, 852 can communicative to determine streaming metrics applying to an end-to-end streaming from device 810 to the streaming interface 824. One component (e.g., streaming engine 812) can determine if fidelity and/or responsiveness problems exist that are bandwidth related. If so, some level of time-shifting of content can be automatically performed to ensure performance issues of the time-shifted content are minimized or eliminated. The portion of the time-shifted content can be calculated and based directly on the expected bandwidth issues involved in end-to-end streaming. For example, if approximately half of the bandwidth needed for smooth HD streaming of video is consistently present in the end-to-end connection, approximately half of the content to-be-streamed can be time-shifted using the NP data store. Different percentages of time-shifted content can be calculated an implemented depending on end-to-end communication specifics.

Using the example where half of the content of a media file is time-shifted, this partial content can be conveyed in many different manners, depending on implementation choices and preferences. In one embodiment, the “half” can represent an initial portion of a media file (where the terminal portion can be acquired as the initial portion is playing, to ensure smooth playback). In another embodiment, it may be preferable to ensure no potentially “playable” content is placed in the NP data store, in which case discrete portions of bits (X of Y) for each frame of video/audio (approximately half of them or X=Y/2, where slightly more than half can be conveyed to account for inefficiencies due to processing requirements to combine content) can be time-shifted. Thus, a NP cached content file (X of Y bits present), may be an intentionally incomplete, corrupt, and otherwise non-playable file, which is only playable when combined with content provided by the server (engine 812) at the time of streaming. In still another embodiment, discrete time segments (ever other second of video, where the video is playable) can be time-shifted. This embodiment can be advantageous in that it is capable of forward queuing, reverse queuing, etc., while showing content on a screen—without having to acquire any additional content (other than that contained in the NP data store) from the streaming engine 814. Combinations of the above approach are also contemplated and can be used (the first few minutes of an hour video is included in it's entirely so playback can be immediately initiated responsive to a play stream command; one second every five of playable video is included for FF cueing; and additional X of Y bits of the remaining content to ensure smooth playback, while minimizing risk of unauthorized capture/conveyance of a persisting form of the video.)

Drawings presented herein are for illustrative purposes only and should not be construed to limit the invention in any regard. In one instance, functionality of modules 854, 856 can be combined into a single unified module. In another embodiment, media playback application 852 can include NP streaming module 854 solely.

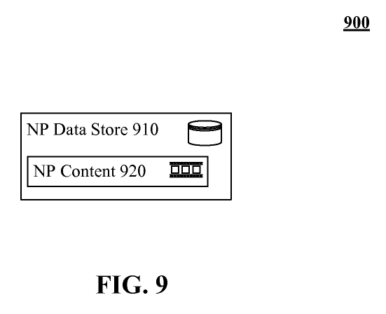

FIG. 9 is a schematic diagram illustrating a system 900 for time-shifting a content streaming request in accordance with an embodiment of inventive arrangements disclosed herein. In system 900, a non-persisting (NP) data store 910 can be associated with NP content 920. NP data store 910 can include, but is not limited to, read only memory (ROM) component, random access memory (RAM) component, digital video recorder, personal computer, laptop, portable media player, mobile phone, personal digital assistant (PDA), and the like. In one instance, NP content 920 can be content encoded for streaming. In another instance, content 920 can be encoded in real-time during streaming by NP data store 910.

In one embodiment, NP data store 910 can include configuration settings for authentication and/or behavior. Configuration settings can include, but are not limited to, server-side settings, client-side settings, and the like. In the embodiment, data store 910 can be configured with subscriber authentication details. For instance, data store 910 can be comprise of account information such as username login and password. In one arrangement of the embodiment, configuration settings can be user established and/or automatically configured by a content provider. For instance, data store 910 can utilize configuration settings from a media playback application to perform auto-configuration functionality. In the embodiment, data store 910 can include operational settings for data store 910.

Drawings presented herein are for illustrative purposes only and should not be construed to limit the invention in any regard. In one instance, NP data store 910 can be a distributed computing platform. For instance, NP data store 910 can be a cloud-based content distribution element permitting time-shifting of content requests.

The flowchart and block diagrams in the FIGS. 1-9 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for streaming media content comprising:
identifying a streaming request from a playback device for media content wherein the media content originates from a unique content source, wherein the unique content source is remote from the playback device, wherein content source is communicatively linked to the playback device via a public network;
before submitting the request to the unique content source, querying a non-persisting data store for the media content, wherein the non-persisting data store comprises previously acquired digital media which is either encrypted, partially conveyed, or combinations thereof so that it remains inaccessible, non-usable, unable to be played back in its entirely, or combinations thereof to a user except, when provided responsive to the streaming request per the method;
when results of the querying produce a match, identifying the media content within the non-persisting data store and conveying the media content from the non-persisting data store to the playback device;
when results of the querying do not produce a match, requesting, via the public network, the media content from the content source and receiving a streaming of the media content to the playback device from the content source in response; and
presenting the media content to the playback device.

2. The method of claim 1, wherein when results of the querying produce a match:
identifying the media content within the non-persisting data store; and
streaming the media content from the non-persisting data store to the playback device, wherein the playback device is unable to distinguish at least one of plurality of sources the streamed media is provided by, wherein the streamed media content is provided by the non-persisting data store instead of being provided from the remote content source.

3. The method of claim 1, wherein the playback device and the non-persisting data store connected to each other via a home network, wherein the non-persisting data store is controlled and managed by a home media server, the method further comprising:
the streaming request initiating from the playback device, where the initiated streaming request is directed to the unique content source;
the home media server intercepting the streaming request;
responsive to the intercepting of the streaming request, the home media server performing the querying of the non-persisting data store and determining that the results of the querying produce a match;
the home media server, identifying the media content within the non-persisting data store; and
the home media server streaming the media content from the non-persisting data store to the playback device, wherein the intercepted streaming request is not sent to the unique content source.

4. The method of claim 1, wherein the playback device comprises a streaming engine for presenting streamed digital content and a file engine for presenting stored digital content, said method further comprising:
when results of the querying produce a match, using the file engine of the playback device to present and playback the media content of the non-persisting data store; and
when results of the querying do not produce a match, using the streaming engine of the playback device to present and playback the media content streamed from the content source.

5. The method of claim 1, wherein the presenting of the media content occurs responsive to the streaming request and under a minute from a time a user submitted the streaming request via the playback device, wherein a user is prevented from accessing the media content via the playback device other than though streaming capabilities of the playback device.

6. The method of claim 1, when results of the querying produce a match:
after and responsive to identifying the media content, conveying a message to the remote content source pertaining to the streaming request;
receiving an authorization code from the remote content source in response to the message;
utilizing the authorization code provided by the remote content source to access the identified media content, wherein the identified media content is inaccessible by the playback device in absence of the authorization code.

7. The method of claim 1, further comprising:
a user selecting a plurality of media items from a user specified queue maintained by a content source server associated with the content source; and
the content source server, during a non-peak time when computing resources of the content source server are available by the content source server, conveying over the public network media content for the media items to the non-persisting data store, which is a tangible memory owned by the user and residing within a home network of the user.

8. The method of claim 1, wherein the method is performed by a plug-in component, wherein the plug-in component is associated with the playback device, wherein the plug-in component is at least one of a combination of hardware, firmware, and software.

9. The method of claim 1, wherein the playback device is traditional streaming playback device, wherein the playback device is modified to perform the method of claim 1.

10. The method of claim 1, further comprising:
executing a predictive algorithm to determine a predictive queue of media items that a specific recipient is likely to request for streaming in the future;
conveying the media items in the predictive queue from the content source to the non-persisting data store before the streaming request is received, wherein a user of the playback device is prevented from knowing which media items are in the non-persisting data store.

11. The method of claim 1, wherein the previously acquired digital media in the non-persisting data store comprises partially conveyed digital content, wherein when conveying the partially conveyed portion of the media content within the non-persisting data store to the playback device, concurrently acquiring a remainder of the partially conveyed portion of the media content from the content source, said method comprising:
combining the partially conveyed portion of the media content from the non-persisting data store and the remainder from the content source, wherein the presenting of the media content of the playback device presents the combined results of the partially conveyed portion and the remainder.

12. The method of claim 1, wherein the previously acquired digital media in the non-persisting data store comprises partially conveyed digital content, wherein X of Y needed bits for each frame of the digital content is included in the partially conveyed digital content, wherein Y-X is at least one, wherein the partially conveyed digital content file is unable to be played without obtaining the missing Y bits, which are acquired from the content source responsive to the streaming request being identified and processed.

13. The method of claim 1, wherein the previously acquired digital media in the non-persisting data store comprises partially conveyed digital content, wherein said partially conveyed digital content comprises a repeating interval of continuous time-segmented content followed by a repeating interval of a continuous gap of time-segmented content, wherein the forward and reverse queuing functions of the playback device use the continuous time-segmented content in the non-persisting data queue to enable viewing of media content during queue functions while not requiring additional content to be acquired from the content source to enable the viewing of the media content during queue functions.

14. The method of claim 1, wherein the identifying of the streaming request, the querying, the identifying and conveying of media content when results product a match, the receiving of the media content when results do not produce a match, and the presenting are performed by at least one computer program when the at least one computer program is executed on hardware, wherein the at least one computer program is stored in a tangible, non-transitory storage medium.

15. A system for selectively streaming media content comprising:
a streaming interface associated with a playback device, wherein the streaming interface comprises of at least one of a plurality of streaming controls configured to initiate a streaming request for a streaming content to a remote content source associated with a remote content provider;
a streaming engine able to intercept the streaming request for the streaming content initiated by at least one of the plurality of streaming controls, wherein when intercepting the streaming request the streaming engine performs a local query to determine the availability of the streaming content in a non-persisting data store prior to a remote query to the remote content source for the streaming content; and
a non-persisting data store associated with the playback device configured to permit access to the streaming content, wherein the media content is encrypted in a protected manner and remains inaccessible to a user except, when provided responsive to the streaming request.

16. The system of claim 15, wherein the non-persisting data store is associated with a content provider issued equipment, wherein the equipment is a computing device capable of receiving a streaming content.

17. The system of claim 15, wherein the streaming interface is generated by execution of a computer program by hardware, wherein the streaming engine is a computer program stored on a tangible storage medium that is executable by hardware, and wherein the non-persisting data store is a tangible storage medium.

18. A method for time-shifting a streaming content request comprising:
conveying a streaming content request at a first time from a requesting entity to a remote content source, wherein the first time occurs immediately in response to a user-initiated request, wherein the remote content source is a content provider associated with a content, wherein the content is content able to be streamed;
receiving a content from the remote content source at a second time and associating the content with a non-persisting data store, wherein the second time is not immediately subsequent to the first time;
streaming the content associated from the non-persisting data store to a requesting entity at a third time, wherein the third time is significantly different from the second time; and
presenting the content within a streaming interface at the third time.

19. The method of claim 18, wherein the receiving step is performed when resources associated with the remote content source is sufficiently available.

20. The method of claim 18, wherein the streaming is responsive to a user initiated playback action.

21. The method of claim 18, wherein the user initiated request is at least one of a plurality of interactions with a streaming queue, wherein the streaming queue is a queue comprising a set of content items selected by at least one of a user and a machine determined action.

22. The method of claim 18, wherein the streaming step is indistinguishable from a remote streaming action, wherein the remote streaming action is streaming a content from a remote content source.

23. The method of claim 18, where the non-persisting data store is a protected environment controlled by the remote content source.

24. The method of claim 18, wherein the streaming step utilizes at least one of a plurality of real-time streaming technologies.

25. The method of claim 18, wherein the streaming step is performed by a geographically proximate entity different from the remote content source, wherein the third party entity is communicatively linked to the requesting entity via a public network.

26. The method of claim 18, further comprising:
prior to performing the streaming step, requesting an authorization code from the remote content source for accessing the content associated with the non-persisting data store; and
receiving the authorization code from the remote content source; and
accessing the content associated with the non-persisting data store utilizing the authorization code.

27. The method of claim 18, wherein the conveying, the receiving, the streaming, and the presenting are performed by at least one computer program when the at least one computer program is executed on hardware, wherein the at least one computer program is stored in a tangible, non-transitory storage medium.
